(19) United States
(12) Patent Application Publication
(10) Pub. No.: US 2009/0297664 A1
(43) Pub. Date: Dec. 3, 2009

(54) LOW TEMPERATURE FORMING OF FEEDS

(75) Inventors: Dennis Forte, Wodonga (AU); John Crosbie Goold, Camperdown (AU); Edward J. Meysztowicz, Camperdown (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: Jorrocks Pty Ltd, Camperdown (AU)

(21) Appl. No.: 12/130,018

(22) Filed: May 30, 2008

(51) Int. Cl. A23J 3/00; A23P 1/12

(52) U.S. Cl. 426/62; 426/61; 426/578

(57) ABSTRACT

This application relates to a method and composition for low temperature forming of starch based and/or protein based feeds. It is particularly related to human or animal feeds containing inactivated probiotics, prebiotics, enzymes, inactivated yeasts, botanical extracts and dairy components. The low temperature extrusion process provides a means for the formation of a suitable starch and/or protein-based structure, as a carrier for temperature and/or pressure sensitive ingredients.

This invention relates to a new method and composition for low temperature forming of starch based and/or protein based feeds. It is particularly related to human or animal feeds containing inactivated probiotics, prebiotics, enzymes, inactivated yeasts, botanical extracts and dairy components.

### BACKGROUND

Animal (and some human) feeds typically are supplied as pellets or pieces. Pellets are typically formed from a starch and/or protein containing base ingredient, eg wheat or corn, mixed with a variety of other ingredients. The starch or protein containing base ingredient has a functional as well as a nutritional role in the pellet. Its functional role is to bind all other ingredients together.

Binding of ingredients typically occurs because of the gelatinization of starch or the denaturation of protein. Both of these chemical processes are usually carried out at elevated temperature and/or pressure.

Starch is typically present within the grain source as granules. When heat is applied to starch granules in the presence of excess moisture the granules swell, break open and merge with other granules. This process typically results in a paste, which acts as a glue to bind all other ingredients together.

Proteins are bio-polymers of amino acids linked together via a type of bond called a peptide bond. Proteins are very large macromolecules having molecular weights exceeding several million. The unique features of the various types of protein depend upon their chain length and the mix of amino acids that make up the sequence.

Proteins, in their native state, fold on themselves and create a very specific three-dimensional structure. This unique shape is a key to the functionality of the given protein in its indigenous state and impacts how the protein behaves (with respect to its chemical and physical properties). Proteins are generally described as having differing levels of structure. The primary structure refers to the amino acid sequence forming the backbone of the molecule. The secondary structure describes the folding of the protein chains which are held and maintained in position primarily by hydrogen bonding between adjacent coils of the molecule. The tertiary structure (which is present in native protein) describes how the secondary structure of the molecule is arranged in space. This is sometimes referred to as the globular structure.

When the three-dimensional structure is altered, protein properties irreversibly change. This process of alteration is referred to as denaturation. The important factors involved in the denaturing of proteins are: heat, agitation, solvents and the presence of salts.

When the temperature of a suitable protein source is elevated, in the presence of a suitable solvent (such as water) the result is extensive unfolding of the protein with loss of its native globular, three-dimensional shape. After this unfolding occurs, the relatively linear protein chains are free to reorient and recombine, thereby leading to the formation of water stable and heat stable structures.

The aligning of protein molecules can occur in a shear field characterized by a velocity gradient. The shear field can be generated via the action of a mixer (such as a Z-arm mixer) or via the flow within a confined channel (e.g. an extruder die). The reactive sites on adjacent molecules come sufficiently close so that intermolecular bonds form and maintain the denatured fibre state. The processes are shown schematically in FIG. 1.

Feed pellets and kibble typically are formed by mechanical means. One such means typically involves introducing moisture in the form of water or steam into the ingredients and forcing the aggregate (via an auger or screw arrangement) through a tube or barrel. The ingredients are compressed and forced along the barrel by the screw arrangement within the barrel. The compression of the ingredients may be effected via a number of alternative screw designs. The shaft of this screw may increase in diameter the further it is within the barrel. Additionally, the flights of the screw may be spaced closer together the further it is in the barrel. The effect of screw shaft diameter increases and increasingly closer spacing of screw flights is to decrease the internal volume of the barrel.

The forceful compression of feed ingredients by the screw through the barrel and into a decreasing volume of space creates high pressures within the barrel. Further, high pressures lead to greater friction (due to the rotation of the screw assembly) between the components of the ingredients. The rotational speed of the screw also has a significant influence upon the development of the frictional forces. This greater friction results in an increase in temperature. This process, if carried out under appropriate conditions, can lead to the gelatinisation of starch ingredients and/or denaturation of the protein and is called extrusion cooking.

At the end of the barrel, a flat plate with a series of openings is provided; called a die plate. The die plate assists in maintaining pressure on ingredients within the barrel. Further, ingredients are forced through the die plate openings and typically form an extruded, structured rod. The structure of the extruded product may be defined as dense or may exhibit a significant degree of expansion, depending upon the operating conditions of the extruder and also the die design. A rotating knife or blade with a visual resemblance to an aeroplane propeller may be affixed to the die plate. This results in the cutting of the extruded rod into pellets or kibble. The apparatus used for extrusion cooking is typically called an extruder. An extruder may be provided with a single screw or a double screw arrangement within the barrel.

Another means of mechanically forming a feed involves introducing moisture in the form of water or steam into the ingredients within a continuous mixing device. The feed ingredients are then fed into a circular chamber surrounded by a circular die with a sequence of openings. Further, a lobe situated on the end of an eccentric camshaft is provided within the chamber. As this lobe rotates within the chamber it has the effect of wiping or forcing feed ingredients through the surrounding die openings. A rotating knife is provided outside the die that circumnavigates the die and has the effect of cutting extruded rods into pellets.

The die and chamber arrangement is contained within a larger chamber that is typically bathed in steam. The effect of steam is to partially or fully gelatinise starch components and/or to partially or fully denature protein components in the feed ingredients and assist in the formation of the pellet. This process is called pelletising or steam pelletising and the apparatus used for this purpose is typically called a pelletiser or steam pelletiser.

The traditional technology for the manufacture of textured vegetable protein (TVP) is presented schematically in FIG. 2. The process typically employs the use of a single screw extruder.

Taking into consideration the information outlined above when reviewing this process for the manufacture of TVP we find that:
the process time is quite short (t<40 seconds) leading to non-uniform hydration of the protein substrates.
there is a significant amount of heat generated due to viscous dissipation, leading to an elevated process temperature (T>130° C.) and an elevated pressure (P>35 bar).
these aggressive process conditions can result in:
   the formation of very strong inter-molecular bonds resulting in the development of very stable three-dimensional structures.
   the molecular degradation of the protein molecules to generate a range of low molecular weight compounds (amino acids and peptides) which are then available to undergo further chemical reactions.
   the chemical decomposition of lysine, serine and threonine (which can result in a significant reduction in the nutritional value of the food).
   the development of a broad range of flavour compounds. (These may prove to be palatable or not.)
the rapid loss of pressure and temperature at the die results in a significant amount of flash moisture loss from the product. This results in the formation of a porous structure.

One of the key areas of recent development in the field of protein extrusion has been the relatively recent advent of the high moisture extrusion cooking (HMEC) process technology. This technology has proven to be very successful for the preparation of meat/fish analogues for either the pet food industry or for use in vegetarian meals. The important features of this technology consist of:
Optimal utilization of the functional properties of the protein source.
Utilization of low value meat/fish by-products.
Operation of the process at elevated moisture content (55-70% w/w), elevated temperature (T>150° C.) and elevated pressure (P>50 bar).
Typically involves the use of a twin screw extruder,
Generation of an amorphous molten mass and the avoidance of the formation of steam during the discharge of the product from the die due to the cooling action of the extended die length. (It is typical for the product to be discharged at a temperature of less than 90° C.)
Promotion (via the die geometry) of the formation of extended lengths of fibrous structures resulting from the alignment and cross-linking of the protein substrates present within the molten mass. (The length:diameter ratio of the die is typically>50.)
The freezing of these structures within the body of the long cooling die.

The major benefits to be gained via the implementation of this technology include:
The ability to utilize significantly higher levels of the low-value meat/fish by-product sources in the formulation.
The formation of significantly more fibrous structure than can be achieved via the traditional process.
The production of meat analogues and fish analogues with significantly higher market acceptance.

The two broad categories of currently utilized protein extrusion technologies employ extremely aggressive processing conditions. Whilst being beneficial to the preparation of optimally bound protein-based structures, such conditions render these processes unsuitable for the preparation of products incorporating temperature and/or pressure sensitive materials.

A disadvantage of both the extrusion cooking and the pelletising method is that the pressures and temperatures generated within the extruder barrel or pelletising chamber may denature or destroy temperature or pressure sensitive feed ingredients. A class of ingredients that are typically heat or pressure sensitive are those that may be provided for the purpose of exerting a physiological effect on a human or animal. The temperature generated in an extruder barrel may be 150 degrees Celsius or higher. Many ingredients supplied for the purpose of exerting a physiological effect may be significantly denatured at temperatures above 100 degrees Celsius.

Such physiologically-active ingredients are typically provided in a powder form. While it is feasible to measure out a dosage of such a powder and apply it separately to a feedstuff it is more convenient to incorporate the same dosage within a feed pellet. This greatly simplifies and combines the task of feeding and dosage administration. A method allowing the formation of pellets or kibble without denaturing ingredients supplied for the purpose of exerting a physiological effect on a human or animal would be advantageous.

A key group of ingredients supplied for the purpose of exerting a physiological effect on a human or animal are a class of bacteria called probiotics. Probiotics may be supplied in a live state, that is, capable of metabolizing nutrients and proliferating. Probiotics may also be supplied in an ‘inactivated’ state, that is, incapable of metabolizing nutrients and proliferating. Where probiotic bacteria are supplied in the inactivated state they still maintain an identifiably approximate physical formation or structure to that manifested in the live state. This method concerns the use of inactivated probiotic bacteria.

Where inactivated probiotic bacteria may be passed through an extrusion cooking process the high temperatures and pressures in the extruder barrel may break apart or atomize the physical structure of the bacteria. This physical structure is important in the function of inactivated probiotic bacteria in exerting a beneficial physiological effect on a human or animal. A method for forming a feed pellet containing inactivated probiotic bacteria that does not break apart or atomize the physical structure of the inactivated probiotic bacteria, or at least minimises those effects, would be advantageous.

A further key group of ingredients supplied for the purpose of exerting a physiological effect on a human or animal are a class of bacteria or bacterial extracts or plant extracts called prebiotics. Where prebiotics may be passed through an extrusion cooking process the high temperatures and pressures in the extruder barrel may break apart or atomize the physical structure of the prebiotics or cause oxidation or chemical alterations to the prebiotics.

This physical structure, non oxidized or non chemically altered state of the prebiotics is important in the function of the prebiotics in exerting a beneficial physiological effect on a human or animal. A method for forming a feed pellet containing prebiotics that does not break apart or atomize or oxidize or chemically alter the structure of the prebiotics, or at least minimises those effects, would be advantageous.

A further key group of ingredients supplied for the purpose of exerting a physiological effect on an animal are a class of bacterial, plant or animal extracts, called enzymes. Enzymes act to catalyse chemical reactions. A desired chemical reaction in feed is, for example, the breaking down or hydrolysis of starch molecules into simpler units that are more readily digestible by a human or animal. Where enzymes may be passed through an extrusion cooking process the high temperatures and pressures in the extruder barrel may cause oxidation or chemical alterations to the enzymes that detract from their ability to act as chemical reaction catalysts. The non oxidized or non chemically altered state of the enzymes is important in the function of the enzymes in exerting a beneficial physiological effect on a human or animal. A method for forming a feed pellet containing enzymes that does not significantly oxidize or chemically alter the structure of the enzymes, or at least minimises those effects, would be advantageous.

A further key group of ingredients supplied for the purpose of exerting a physiological effect on a human or animal are a class of fungi or fungal extracts called yeasts. Yeasts may be supplied in an active state, that is, capable of metabolizing nutrients and proliferating. Yeasts may also be supplied in a ‘inactivated’ state, that is, incapable of metabolizing nutrients and proliferating. Where yeasts are supplied in the inactivated state they still maintain the same physical formation or structure manifested in the live state. This method concerns the use of inactivated yeasts.

Where inactivated yeasts may be passed through an extrusion cooking process the high temperatures and pressures in the extruder barrel may break apart or atomize the physical structure of the inactivated yeasts and may cause oxidation or chemical alterations to the yeasts that detract from their ability to exert a physiological effect on an animal. A method for forming a feed pellet containing inactivated yeasts that does not break apart or atomize the physical structure of the inactivated yeasts or cause oxidation or chemical alterations to the inactivated yeasts, or at least minimises those effects, would be advantageous.

A further key group of ingredients supplied for the purpose of exerting a physiological effect on a human or animal are plant extracts or components called “botanicals”. Where botanicals may be passed through an extrusion cooking process the high temperatures and pressures in the extruder barrel may cause oxidation or chemical alterations to the botanicals. The non oxidized or non chemically altered state of the botanicals is important in the function of the botanicals in exerting a beneficial physiological effect on an animal. Methods for forming a feed pellet containing botanicals that does not oxidize or chemically alter the structure of the botanicals, or at least minimises those effects, would be advantageous.

This physiological effect of inactivated probiotics or prebiotics or enzymes or inactivated yeasts or botanicals is dependant on the correct dosage of any of the above ingredients being supplied. Where the any of the above ingredients may be damaged or denatured the correct dosage may no longer be supplied in the feed or be relied upon to be present. Further, any heat or pressure related damage may render the feed ingredient ineffective in any dosage. A method for forming a starch based and/or protein based feed pellet containing inactivated probiotics or prebiotics or enzymes or inactivated yeasts or botanicals or any combination thereof that allows the reliable administration of the correct dosage would be advantageous

The state of the art concerning the administration of probiotics in feeds maintains that the probiotics must be live in order to exert a physiological effect. Live bacteria are inherently unstable and require refrigeration to slow their rate of metabolization and dying. Where the state of the art recognizes live bacteria as the agents exerting a physiological effect there is a consequent demand created to warrant the quantity and integrity of the live probiotic component in a feed.

The quantity and integrity of a live probiotic component may only be warranted within a narrow range of conditions, specifically the maintenance of any product containing live probiotics in a refrigerated state and the use of the same product within a defined time limit that typically demonstrates a reasonable expectation of live bacteria being present in a warranted quantity. This last circumstance is typically identified as the shelf life of the product. The shelf life of a product containing live probiotics typically ranges from 7 days to two years. The longest shelf life is associated with a pure live probiotic powder kept at a moisture level of 5% or less in a refrigerated state. Admixtures of feed and probiotics would not practically achieve a shelf life greater than 90 days.

The requirement to refrigerate product adds significant cost to the process of product storage, distribution and presentation, as refrigeration costs must be met. The requirement to refrigerate also limits product storage, transport and presentation options, as specialised refrigerated options must be provided. A method for utilising inactivated probiotic bacteria to provide a physiological effect would be advantageous. The use of inactivated probiotic bacteria would negate the need for refrigerated storage, transport and presentation options and extend product shelf life above 90 days.

Most significantly, live probiotic bacteria are intolerant of the pressures and temperatures typically generated within the extruder barrel of the extrusion cooking process or pelletising chamber of the pelletising method of feed manufacture. As a consequence, live probiotic bacteria cannot be effectively incorporated within feed products during extrusion or pelletising. Live probiotics may only be applied post extrusion or pelletising, increasing the costs of manufacture.

The use of inactivated probiotic bacteria as a physiologically active ingredient allows the incorporation of a probiotic component within feeds during extrusion or pelletisation. The consequent simplification and lowering of manufacturing costs is greatly advantageous.

The present invention seeks to provide a method that incorporates the above processing advantages. The development of a low temperature extrusion process might provide an alternative means of achieving the desired objective: the formation of a suitable starch and/or protein-based structure, as a carrier for temperature and/or pressure sensitive ingredients.

### SUMMARY OF THE INVENTION

In a first embodiment, the invention provides a method for cold extrusion of a human or animal feed including:
providing a dry blend of formulation ingredients, including functional protein and active ingredients (as herein defined);
mixing (prior to processing) to ensure that all of the formulation ingredients, especially the active ingredients, are uniformly dispersed throughout the dry blend;
providing an appropriate proportion of water and/or steam to ensure that the total moisture content of the mixed ingredients is substantially within the range of 20 to 35% w/w;
providing sufficient hydration time to allow substantially complete wetting of the functional protein;
providing sufficient work input to develop a protein-based structure, (which will subsequently hold the product together) such that the specific mechanical energy (SME) is substantially within the range 0.035<SME<0.055 kW.hr kg⁻¹;
ensuring that the maximum exposure temperature is less than T=about 100° C.;
ensuring that the maximum exposure time (to the elevated temperature) is substantially within the range 20<t<40 seconds; and
providing a low temperature drying process (Tₐᵢᵣ<70° C.) to reduce the moisture content to the required level for microbial stabilization (as herein defined).

In a second embodiment, the invention provides a method that includes the use of a dry, pre gelatinized starch base as a significant starch component of the feed ingredients. As the starch has been gelatinized it can be provided in a form where it readily binds and holds other ingredients together with the minimum application of moisture, heat and/or pressure.

A pre gelatinized starch base may be formed from any one or more of the following ingredients:

breadcrumbs, gelatinized wheat, oats, sorghum, barley, rice or corn flour, gelatinized cracked or milled wheat, oats, sorghum, barley, rice grains or corn kernels or parts thereof, gelatinized potato starch.

The method for low temperature forming of starch based feeds includes the following steps:
combining a mixture of dry pre gelatinized starch base with inactivated probiotics (as herein defined);
providing the pre gelatinized starch base and inactivated probiotic admixture as an additive in the range of about 1% -about 90% (weight:weight) to any one or more of the following ingredients—wheat, oats, sorghum or barley grain or corn kernels or flours or milled parts or extracts thereof, rice grain or flours or milled parts or extracts thereof, lupins, pulses, soya beans or flours or milled parts or extracts thereof, any other palatable feed grains and grain by products, meat, meat and bone meal, meat meal and meat extracts or liquid digests derived from bovine, ovine, porcine, piscine, avian or other edible animal species, tallow or vegetable oil;
exposing the pre gelatinized starch base and inactivated probiotic admixture combined with other ingredients to moisture in the form of water or steam;
introducing the moistened admixture and other ingredients into an extrusion cooker or pelletiser;
adjusting the extrusion cooker or pelletiser so that the temperature of ingredients within the extruder barrel or pelletising chamber lies within the range of about 50 degrees Celsius to a maximum of about 100 degrees Celsius; and
drying the extruded or pelletised product using ambient air or air heated to a temperature within a range of about 50 degrees Celsius to a maximum of about 100 degrees Celsius; or, alternatively, flash drying the product using air at a temperature greater than about 100 degrees Celsius on the condition that the product temperature is not elevated above about 100 degrees Celsius.

In another embodiment, the invention provides a composition for a starch based feed including:
an admixture of pre gelatinized starch base and inactivated probiotics (as hereinbefore defined) in a range of about 1% -about 90% (wt:wt) with any one or more of the following ingredients—wheat, oats, sorghum or barley grain or corn kernels or flours or milled parts thereof, rice grain or flours or milled parts thereof, lupins, pulses, soya beans or flours or milled parts thereof, any other palatable feed grains and grain by products, meat and bone meal, meat meal and meat extracts or liquid digests, tallow or vegetable oil.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 illustrates alignment of protein molecules in a shear field characterized by a velocity gradient.

FIG. 2 illustrates traditional technology for the manufacture of textured vegetable protein (TVP).

FIG. 3 illustrates a relationship between Product Water Activity and various Degradation Reactions.

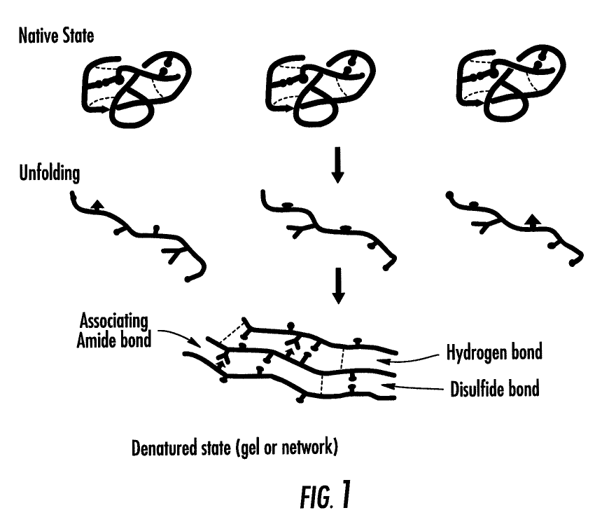

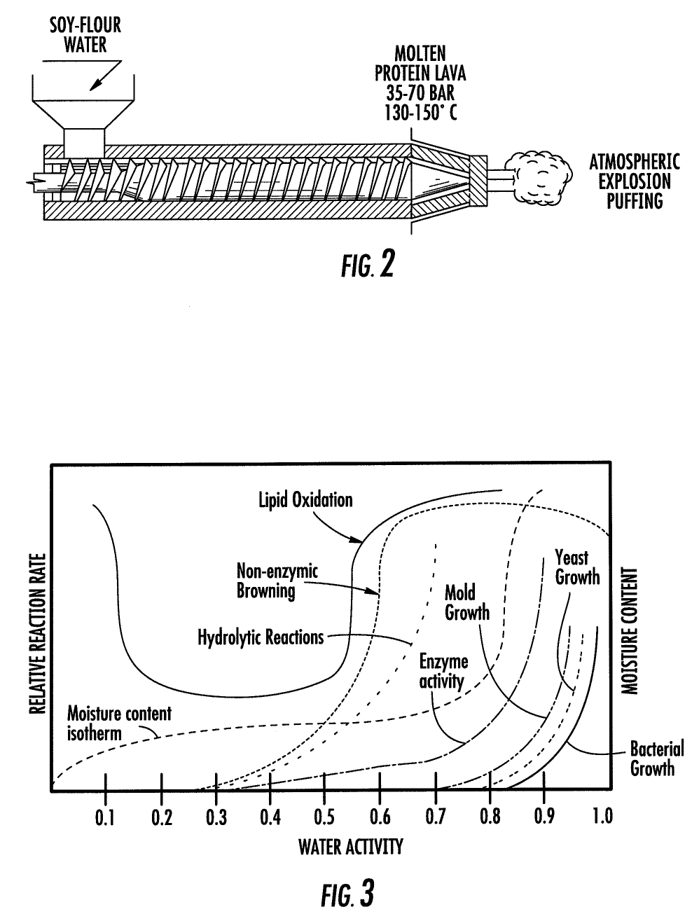

### PREFERRED ASPECTS OF THE INVENTION

In relation to the first embodiment of the invention, with the maximum exposure temperature at more than T=100° C. it is believed that the probiotic “pattern” is destroyed leading to a loss of effectiveness. It is preferred that the maximum exposure temperature is below pasteurisation temperature and most preferred that it is below about 60° C.

Preferably, the hydration time is substantially within the range of 50<t<100 seconds.

A preferred semi-moist pet food product formulation, suitable for processing via the proposed technology is presented in Table 1.

Alternative product formulations include the following two recipes, in which the ingredients are listed in order of the level of inclusion in the total formulation:

Recipe 1

Ingredients listing—vital wheat gluten, beef tallow, meat meal, rice hulls, Y+™, dried bread crumbs, sugar, yoghurt powder, vegetable oil, salt, vitamins, mineral blend. (Y+ is a commercial product containing killed probiotics, prebiotics, yeast and commercial plant extracts.)

Proportions—protein (30.5% w/w), Carbohydrate (17.3%), fibre (26.3%), ash (8.8%).

Recipe 2

Ingredients listing—beef tallow, meat meal, poultry meal, dried bread crumbs, rice hulls, whole wheat, vegetable oil, red iron oxide, vitamins, mineral blend.

Proportions—protein (30.2% w/w) carbohydrate (18.2%), fat (26.1%), fibre (5.1%), ash (10.3%).

Preferably, the Formulation Ingredients include one or more probiotics selected from one or more of the following group used singly or in combination and used whole or in fractions of the whole bacterial organism:

Bacillus coagulans, Bacillus lichenformis, Bacillus subtilis, Bifidobacterium sp., Enterococcus faecium, Lactobacillus acidolphilus, Lactobacillus casei, Lactobacillus fermentum, Lactobacillus johnsonii, Lactobacillus paracasei, Lactobacillus reuteri, Lactobacillus ruminsis, Lactobacillus rhamnosus, Pediococcus acidilacticii.

The total drying duty can be further optimized by formulating the product as a semi-moist product. This will require inclusion of the appropriate humectants into the formulation. In this case sugar, salt and glycerol have been used as humectants. The presence of glycerol, together with the vegetable oil and the additional water (products may be formulated at up to 15% w/w moisture content vs. 8-10% w/w for standard dry dog food) act as plasticizers, ensuring that the product retains a rubbery texture. The type of formulation outlined in Table 1, prepared to a total moisture content of w≈15% w/w, will result in a water activity of approximately a_{w}≈0.70 to 0.73.

The following preferred aspects of the invention apply equally to either of the above starch-based embodiments of the invention (i.e. the method or composition).

In order to ensure that process temperatures remain low, it is preferred that the pre-gelatinised starches are cold water setting starches.

Preferably, the admixture of pre gelatinised starch base and inactivated probiotics includes a functional protein source present as at least 15% of the total formulation ingredients. More particularly, it is preferred that the functional protein source is vital wheat gluten.

The probiotics used in the invention may be selected from one or more of the following group used singly or in combination and used whole or in fractions of the whole bacterial organism:

Bacillus coagulans, Bacillus lichenformis, Bacillus subtilis, Bifidobacterium sp., Enterococcus faecium, Lactobacillus acidolphilus, Lactobacillus casei, Lactobacillus fernentum, Lactobacillus johnsonii, Lactobacillus paracasei, Lactobacillus reuteri, Lactobacillus ruminsis, Lactobacillus rhamnosus, Pediococcus acidilacticii.

In a preferred embodiment, a mixture of dry, pre gelatinized starch base is combined with inactivated probiotics and prebiotics. The prebiotics may include any of the following prebiotics, singly or in combination: galacto-oligosaccharide,lactulose, lactosucrose, fructo-oligosaccharide, raffinose, stachyose and malto-oligosaccharide.

In a further preferred embodiment, a mixture of dry, pre gelatinized starch base is combined with inactivated probiotics, prebiotics and enzymes. The enzymes may include any of the following enzymes, singly or in combination: alpha-amylase, beta-amylase, cellulase, alpha-galactosidase, beta-glucanase, beta-glucosidase, glucoamylase, lactase, pectinase, xylanase, lipase and protease.

In a further preferred embodiment, a mixture of dry, pre gelatinized starch base is combined with inactivated probiotics, prebiotics, enzymes and inactivated yeasts including any of the strains of yeasts of the species Saccharomyces cerevisiae used singly or in combination, used whole or in fractions of the whole yeast organism.

In a further preferred embodiment, a mixture of dry, pre gelatinized starch base is combined with inactivated probiotics, prebiotics, enzymes, inactivated yeasts and botanicals including garlic or garlic extracts used singly or in combination.

In a further preferred embodiment, a mixture of dry, pre gelatinized starch base is combined with inactivated probiotics, prebiotics, enzymes, inactivated yeasts or botanicals and dry, lactose free milk powder or lactose free yoghurt powder.

In a further preferred embodiment, a mixture of pre gelatinized starch base is combined with inactivated probiotics, prebiotics, enzymes, inactivated yeasts, botanicals, vitamin and mineral supplements, anti oxidants, preservatives, and colourings.

### EXAMPLES

A product formulated and prepared to these specifications will exhibit an optimal Shelf Life since the impact of the numerous Product Degradation Reactions commonly associated with product spoilage will be minimized. The relationship between the Product Water Activity and the various Degradation Reactions is presented schematically in FIG. 3.

### Example 1

### High Moisture Extrusion Cooking (HMEC)

General Information
The preparation of Meat Analogues and Seafood Extenders via the process known as High Moisture Extrusion Cooking (HMEC) is becoming more popular as a means of better utilizing lower grade raw material sources for both Human Consumption and also in Premium Pet Food applications.
At High Moisture Contents (>50% w/w), Viscous Dissipation is minimized due to the low Melt Viscosity. The Temperature Rise is therefore, most significantly influenced by the Conductive Heat Transfer.
Typical composition of the Defatted Soy Flour (DSF)

| | | | |
|---|---|---|---|
| Protein | 55% to 65% | Nitrogen Solubility Index | 30% |
| Fat | 3% to 5% | | |
| Moisture | 8% to 10% | | |
| Ash | 4% to 6% | | |

DSF (at 60% w/w moisture content) will melt at T=130° C. It is typical to target a Melt Moisture Content in the range of 55<w<65% w/w for most HMEC applications.
The (uniform) Melt Temperature above 130° C. is a critical parameter for the protein cross-linking reaction. The Tensile Strength of products will increase as the melt temperature rises. The maximum is achieved at T=180° C. Thereafter the tensile strength reduces once again.
The maximum tensile strength is typically achieved at pH=7.0; the strength being significantly reduced at either Alkaline or Acidic conditions.
The tensile strength is negatively influenced by the inclusion of significantly high levels of Oil/Fat (o>15% w/w).
Under high temperature extrusion, the protein bodies are not dissolved, but melt and fuse together by Protein-Protein Interactions, resulting in an Amorphous Melt which may be readily extruded through a die.
The use of a Die Geometry incorporating Extended Flow Paths promotes the development of an Axially Oriented Structure. This type of structure can, under controlled conditions lead to the formation of Meat-like Fibres.
The use of a Long Cooled Die also allows the protein matrix to contain longitudinally oriented “bubbles”, which give products having the layered characteristics of meat.
The mechanism involved in the cross-linking reaction is not fully understood. The formation of Peptide Bonds (—COOH+—NH₂→—CONH—+H₂O) is a Condensation Reaction and, in general is not favoured by wet conditions.
It is more likely that Disulphide Bonding (Covalent Bonding) plays a more significant role in the formation of the structure.
The inclusion of Water Absorbent Materials such as Starch can improve the process by controlling the amount of “free” water available.
The Texturization Process can be described by the process shown below. The denatured protein is first transported into a “melting zone” and then into a “reaction zone”. After the initial reaction, the proteins need higher temperature for the melting process because they are more cross-linked. Following the melting, they have enough fluidity to deform and pass into the die. While the melt passes through the cooled die, the additional shear on the hot product aligns the reacted proteins into filaments which are oriented in the extrusion direction. After sufficient cooling in the die, the extrudate emerges from the die with a well-aligned protein fibre matrix.
Some of the typical Formulation Ratios used in the HMEC process are:

Kamaboko

| | |
|---|---|
| Minced Fish | 90.0% |
| Wheat Flour | 6.5% |
| Salt | 3.5% |

Sardine

| | |
|---|---|
| Sardines | 70.0% |
| Defatted Soy Flour | 30.0% |

Basic Fibre Structure

| | |
|---|---|
| DSF | 40.0% |
| Egg White | 10.0% |
| Water | 50.0% |

Pet Food

| | |
|---|---|
| DSF | 15.0% |
| Meat By-Products | 40.0% |
| Wheat Gluten | 30.0% |
| Wheat Flour | 15.0% |

Extrusion Process Design
The use of a Preconditioner is beneficial (if available). The Target Discharge Temperature should be T_{downspout}=60-80° C. The Target Residence Time should be at least, t=60 to 90 seconds.
The Preconditioner allows the initiation of the Hydration of the Dry Feed, promotes Uniform Mixing of the Meat Slurries (if used) with the Dry Feed and also initiates the Cooking Reactions.
A typical Barrel Temperature Profile would be as follows:

| | | | | | |
|---|---|---|---|---|---|
| 20 | 80 | 120 | <140 | 90 | 60-70 |

| | | |
|---|---|---|
| Inlet | Cooking | Cooling/Forming |

Screw Profile Design
The Screw Profile recommended for this type of duty will consist of three distinct sections. These are:
   Feed Section—This section of the machine is designed to provide a high Volumetric Conveying Capability, thereby ensuring that the extruder is able to operate without “flooding”.
   Compression/Transition Section—This section of the Screw Profile is responsible for the transformation of the Ingredients into dough-like material and subsequently into an Amorphous Melt.
   Metering Section—This section of the machine provides the Final Cook and acts as the Primary Pump for the development of the Pressure required to convey the Melt through the Die.
The incorporation of at least six (6) Kneading Disks set at a 90° angle will ensure the uniform distribution of moisture with the dry DSF (or other protein source).
The preliminary recommendation for the type of Screw Profile that would be suitable for this process application is described below.

| | |
|---|---|
| For a Twin Screw | For a Single |
| Extruder (TSE) | Screw Extruder (SSE) |

| Element Type | L/D | Element Type | L/D |
|---|---|---|---|
| Feed | 4.5 | Feed | 4.0 |
| 90° Paddles | 0.5 | TS Lead | 0.8 |
| Lead | 1.5 | 4 × 3 Lobe Mixing Disc | 0.60 |
| 30° Rev Paddles | 1.0 | Shear Lock | 0.15 |
| Lead | 2.0 | TS Lead | 1.8 |
| 30° Fwd Paddles | 1.0 | Shear Lock | 0.15 |
| Lead | 2.0 | 3 × 3 Lobe Mixing Disc | 0.45 |
| 30° Fwd Paddles | 1.5 | TS Lead | 1.8 |
| Lead | 1.0 | Shear Lock | 0.15 |
| Total | 15.0 | Cone Screw | 2.0 |
| | | Total | 12.0 |

Die Geometry
When proteinaceous materials that are sufficiently elastic are forced through Narrow Die Openings, they form a string-like, fibrous structure. Proteins processed and formed in this manner can experience sufficient Die Shear to align them in the extrusion direction.
The Friction (or slip at the wall) and the relative viscosity of materials in the cross-section greatly influence the orientation of the protein fibres.
This suggests that the size of the die opening and the thickness of the extrudate should be limited to achieve extensive alignment.
In order to ensure that the melt is delivered (released) at a temperature below the Boiling Point, the use of a Long Cooled Die is typically recommended.
When the material to be processed includes large amounts of oil/fat, the length of the cooled die should be larger to increase the friction.
It would appear that the Optimal Die Gap is H=5 mm. If the size is significantly smaller the shear is too high and disrupts the structure formation process; any larger than H=10 mm and the shear is insufficient in the central flow region for the formation of a suitable texture. (Product Cooling is also inadequate when the Product Thickness is too large.)
The typical Die Geometry used for the HMEC process is as follows (300<L<600)×(30<W<50)×(5 <H<10) (All dimensions in mm)
The Total Product Flow Rate per Die Hole should be limited to

| | |
|---|---|
| 120 < M_{T} < 170 | (kg hr⁻¹) |

### Example 2

### Textured Vegetable Protein (TVP)

General Information
The processing of various Vegetable Protein sources (Soya, Wheat Gluten and other sources such as Peanut and Extracted Oil Seed) via Extrusion Technology results in the enhancement of the digestibility of the raw material, as well as an improvement in the palatability of the product.
A typical formulation for a TVP for use in a Dry Pet Food application is presented below

| | % |
|---|---|
| Meat/Poultry By-Product | 4.0 |
| Defatted Soy Flour | 50.0 |
| Whole Wheat | 42.5 |
| Pigment | 0.03 |
| Vitamins/Minerals | 3.5 |
| Total | 100.0% |

When assessing the suitability of a given Protein Source for use in the Extrusion Process, the following points should be taken into account:
   The Total Protein Content
   The Total Fat Content
   The Protein Solubility in Water, which is related to the degree of Thermal Damage experience during processing. (This is most readily measured via the Protein Dispersibility Index, PDI or the Nitrogen Solubility Index, NSI)
   The Total Fibre Content
   The Manufacturing Process [Solvent Extraction or Mechanical Expression] (The process will have an impact upon the functionality of the raw material the level Thermal Damage associated with the Mechanical process is typically significantly higher.)

Extrusion Process Design
The use of a Preconditioner is beneficial (if available). The Target Discharge Temperature should be T_{downspout}=60-80° C. The Target Residence Time should be at least, t=60 to 90 seconds.
The Preconditioner allows the initiation of the Hydration of the Dry Feed, promotes Uniform Mixing of the Water and Steam (if used) with the Dry Feed and also initiates the Cooking Reactions.
The typical Processing Conditions to be used for this process application are as follows:

| | |
|---|---|
| Water (into Preconditioner) | 8.0-10.0%^{Note 1} |
| Steam (into Preconditioner) | 8.0-10.0% |
| Oil/Tallow (into Barrel) | 0.5-1.0% |
| Water (into Barrel, if required) | 2.0-4.0% |
| Meat Slurries (if required) | 15.0-35.0% |
| Specific Mechanical Energy Requirement | 0.085-0.115 kW · hr kg⁻¹ |

^{Note 1}The percentages referred to are expressed as a function of the Cereal Flow i.e. % of Dry Powder Feed Rate.

These Process Parameters will yield an Extrusion Melt Moisture Content of w=22.0 to 26.0% w/w. The resultant Melt Viscosity will lead to an appropriate amount of Viscous Dissipation, leading to the desired conditions for effective Product Expansion.
If the product is to be Re-Hydrated prior to use then the Water Absorption Capability can be optimized by the control of the Specific Mechanical Energy.
A typical Barrel Temperature Profile would be as follows:

| | | | | | |
|---|---|---|---|---|---|
| 20 | 80 | 120 | <140 | 130 | 120-130 |

| | | |
|---|---|---|
| Inlet | Cooking | Cooling/Forming |

Screw Profile Design
The Screw Profile recommended for this type of duty will consist of three distinct sections. These are:
   Feed Section—This section of the machine is designed to provide a high Volumetric Conveying Capability, thereby ensuring that the extruder is able to operate without “flooding”.
   Compression/Transition Section—This section of the Screw Profile is responsible for the transformation of the Ingredients into dough-like material and subsequently into an Amorphous Melt.
   Metering Section—This section of the machine provides the Final Cook and acts as the Primary Pump for the development of the Pressure required to convey the Melt through the Die.
The incorporation of at least six (6) Kneading Disks set at a 90° angle will ensure the uniform distribution of moisture with the dry DSF (or other protein source).
The preliminary recommendation for the type of Screw Profile that would be suitable for this process application is described below.

| | |
|---|---|
| For a Twin Screw | For a Single |
| Extruder (TSE) | Screw Extruder (SSE) |

| Element Type | L/D | Element Type | L/D |
|---|---|---|---|
| Feed | 4.5 | Feed | 4.90 |
| 90° Paddles | 0.5 | Shear Lock | 0.15 |
| Lead | 1.5 | Feed | 1.50 |
| 30° Rev Paddles | 1.0 | Shear Lock | 0.15 |
| Lead | 2.0 | TS Lead | 1.50 |
| 30° Fwd Paddles | 1.0 | Shear Lock | 0.15 |
| Lead | 2.0 | TS Lead | 1.50 |
| 30° Fwd Paddles | 1.5 | Shear Lock | 0.15 |
| Lead | 1.0 | Cone Screw-Cut Flight | 2.00 |
| Total | 15.0 | Total | 12.00 |

Die Geometry
One of the key features of this process technology is Die Configuration. There are actually three (3) important components involved in the design. These are:
   The Primary Die—This is used to control the Degree of Fill within the extruder.
   The Expansion Chamber—The role of this chamber is to allow the melt to travel to the Final Die in a Laminar Flow Regime', thereby promoting extensive Fibre Formation.
   The Final Die—This die is used to provide the Final Resistance and is responsible for determining the Finished Product Dimensions (and Shape) and also the Degree of Expansion.
The typical Specific Die Conductance (of the Primary Die) for this process application is found to be

| | |
|---|---|
| 100 < K < 220 | (kg hr⁻¹ mm⁻³) |

The typical Specific Die Conductance (of the Final Die) for this process application is found to be

| | |
|---|---|
| 10 < K < 20 | (kg hr⁻¹ mm⁻³) |

### Example 3

### Starch-based Canine Feed

A recipe for low-temperature formed starch based pellets used as canine feed:

Dry pre gelatinized starch base as described above—40%

Grains or grain components as described above—15%

Meat meals or Meat and Bone meals as described above—40%

Meat digest, tallow—5%.

It will be recognized by persons skilled in the art that numerous variations and modifications may be made to the invention as broadly described and exemplified herein without departing from the spirit and scope of the invention.

TABLE 1
Typical Pet Food Product Formulation

| | Inclusion |
|---|---|
| | Level |
| Ingredient | (% w/w) |
| Functional Protein (from Vital Wheat Gluten, Defatted Soy | 25-55 |
| Flour, Soy Protein Concentrate, Soy Protein Isolate, | |
| Corn Gluten Meal, Mung Beans or Yeast By-products) | |
| Grain Flour (from Wheat, Corn or Rice) | 10-25 |
| Meat/Poultry/Fish By-Product Meals | 15-25 |
| Sugar | 5-10 |
| Glycerol | 4-8 |
| Vegetable Oil | 3-6 |
| Potasium Sorbate | 0.5-1.5 |
| Digest (Palatability Enhancer) | 2-4 |

1. A method for cold extrusion of a human or animal feed including:
providing a dry blend of formulation ingredients, including functional protein and active ingredients (as herein defined);
mixing (prior to processing) to ensure that all of the formulation ingredients, especially the active ingredients, are uniformly dispersed throughout the dry blend;
providing an appropriate proportion of water and/or steam to ensure that the total moisture content of the mixed ingredients is substantially within the range of 20 to 35% w/w;
providing sufficient hydration time to allow substantially complete wetting of the functional protein;
providing sufficient work input to develop a protein-based structure, (which will subsequently hold the product together) such that the specific mechanical energy (SME) is substantially within the range 0.035<SME<0.055 kW.hr kg⁻¹;
ensuring that the maximum exposure temperature is less than T=about 100° C.;
ensuring that the maximum exposure time (to the elevated temperature) is substantially within the range 20<t<40 seconds; and
providing a low temperature drying process (Tₐᵢᵣ<70° C.) to reduce the moisture content to the required level for microbial stabilization (as herein defined).

2. A method according to claim 1 in which the maximum exposure temperature is below pasteurisation temperature.

3. A method according to claim 2 in which the maximum exposure temperature is below about 60° C.

4. A method according to claim 2 in which the hydration time is substantially within the range of 50<t<100 seconds.

5. A method according to claim 1 in which the formulation ingredients include one or more probiotics selected from one or more of the following group used singly or in combination and used whole or in fractions of the whole bacterial organism: Bacillus coagulans, Bacillus lichenformis, Bacillus subtilis, Bifidobacterium sp., Enterococcus faecium, Lactobacillus acidolphilus, Lactobacillus casei, Lactobacillus fermentum, Lactobacillus johnsonii, Lactobacillus paracasei, Lactobacillus reuteri, Lactobacillus ruminsis, Lactobacillus rhamnosus, Pediococcus acidilacticii.

6. A method according to claim 1 in which the formulation ingredients include one or more humectants selected from the group sugar, salt and glycerol.

7. A method for low temperature forming of starch based feeds includes the following steps:
combining a mixture of dry pre gelatinized starch base with inactivated probiotics (as herein defined);
providing the pre gelatinized starch base and inactivated probiotic admixture as an additive in the range of about 1% -about 90% (weight:weight) to any one or more of the following ingredients—wheat, oats, sorghum or barley grain or corn kernels or flours or milled parts or extracts thereof, rice grain or flours or milled parts or extracts thereof, lupins, pulses, soya beans or flours or milled parts or extracts thereof, any other palatable feed grains and grain by products, meat, meat and bone meal, meat meal and meat extracts or liquid digests derived from bovine, ovine, porcine, piscine, avian or other edible animal species, tallow or vegetable oil;
exposing the pre gelatinized starch base and inactivated probiotic admixture combined with other ingredients to moisture in the form of water or steam;
introducing the moistened admixture and other ingredients into an extrusion cooker or pelletiser;
adjusting the extrusion cooker or pelletiser so that the temperature of ingredients within the extruder barrel or pelletising chamber lies within the range of about 50 degrees Celsius to a maximum of about 100 degrees Celsius; and
drying the extruded or pelletised product using ambient air or air heated to a temperature within a range of about 50 degrees Celsius to a maximum of about 100 degrees Celsius; or, alternatively, flash drying the product using air at a temperature greater than about 100 degrees Celsius on the condition that the product temperature is not elevated above about 100 degrees Celsius.

8. A method according to claim 7 in which the pre gelatinized starches are cold water setting starches.

9. A method according to claim 8 in which the admixture of pre gelatinised starch base and inactivated probiotics includes a functional protein source present as at least 15% of the total formulation ingredients.

10. A method according to claim 9 in which the functional protein source is vital wheat gluten.

11. A method according to claim 8 in which the probiotics are selected from one or more of the following group used singly or in combination and used whole or in fractions of the whole bacterial organism:
Bacillus coagulans, Bacillus lichenformis, Bacillus subtilis, Bifidobacterium sp., Enterococcus faecium, Lactobacillus acidolphilus, Lactobacillus casei, Lactobacillus fermentum, Lactobacillus johnsonii, Lactobacillus paracasei, Lactobacillus reuteri, Lactobacillus ruminsis, Lactobacillus rhamnosus, Pediococcus acidilacticii.

12. A method according to claim 11 in which the mixture of dry, pre gelatinized starch base is combined with inactivated probiotics and prebiotics.

13. A method according to claim 12 in which the prebiotics include any of the following, singly or in combination: galacto-oligosaccharide,lactulose, lactosucrose, fructo-oligosaccharide, raffinose, stachyose and malto-oligosaccharide.

14. A method according to claim 13 in which the mixture of dry, pre gelatinized starch base is combined with inactivated probiotics, prebiotics and enzymes.

15. A method according to claim 14 in which the enzymes include any of the following enzymes, singly or in combination: alpha-amylase, beta-amylase, cellulase, alpha-galactosidase, beta-glucanase, beta-glucosidase, glucoamylase, lactase, pectinase, xylanase, lipase and protease.

16. A method according to claim 15 in which the mixture of dry, pre gelatinized starch base is combined with inactivated probiotics, prebiotics, enzymes and inactivated yeasts including any of the strains of yeasts of the species Saccharomyces cerevisiae used singly or in combination, used whole or in fractions of the whole yeast organism.

17. A method according to claim 16 in which the mixture of dry, pre gelatinized starch base is combined with inactivated probiotics, prebiotics, enzymes, inactivated yeasts and botanicals including garlic or garlic extracts used singly or in combination.

18. A method according to claim 17 in which the mixture of dry, pre gelatinized starch base is combined with inactivated probiotics, prebiotics, enzymes, inactivated yeasts or botanicals and dry, lactose free milk powder or lactose free yoghurt powder.

19. A method according to claim 18 in which the mixture of pre gelatinized starch base is combined with inactivated probiotics, prebiotics, enzymes, inactivated yeasts, botanicals, vitamin and mineral supplements, anti oxidants, preservatives, and colourings.

20. A composition for a starch based feed including:
an admixture of pre gelatinized starch base and inactivated probiotics (as hereinbefore defined) in a range of about 1%-about 90% (wt:wt) with any one or more of the following ingredients—wheat, oats, sorghum or barley grain or corn kernels or flours or milled parts thereof, rice grain or flours or milled parts thereof, lupins, pulses, soya beans or flours or milled parts thereof, any other palatable feed grains and grain by products, meat and bone meal, meat meal and meat extracts or liquid digests, tallow or vegetable oil.

21. A composition according to claim 20 in which the pre gelatinized starches are cold water setting starches.

22. A method according to claim 21 in which the admixture of pre gelatinised starch base and inactivated probiotics includes a functional protein source present as at least 15% of the total formulation ingredients.

23. A composition according to claim 22 in which the functional protein source is vital wheat gluten.

24. A composition according to claim 21 in which the probiotics are selected from one or more of the following group used singly or in combination and used whole or in fractions of the whole bacterial organism:
Bacillus coagulans, Bacillus lichenformis, Bacillus subtilis, Bifidobacterium sp., Enterococcus faecium, Lactobacillus acidolphilus, Lactobacillus casei, Lactobacillus fermentum, Lactobacillus johnsonii, Lactobacillus paracasei, Lactobacillus reuteri, Lactobacillus ruminsis, Lactobacillus rhamnosus, Pediococcus acidilacticii.

25. A composition according to claim 24 in which the mixture of dry, pre gelatinized starch base is combined with inactivated probiotics and prebiotics.

26. A composition according to claim 25 in which the prebiotics include any of the following, singly or in combination: galacto-oligosaccharide, lactulose, lactosucrose, fructo-oligosaccharide, raffinose, stachyose and malto-oligosaccharide.

27. A composition according to claim 26 in which the mixture of dry, pre gelatinized starch base is combined with inactivated probiotics, prebiotics and enzymes.

28. A composition according to claim 27 in which the enzymes include any of the following enzymes, singly or in combination: alpha-amylase, beta-amylase, cellulase, alpha-galactosidase, beta-glucanase, beta-glucosidase, glucoamylase, lactase, pectinase, xylanase, lipase and protease.

29. A composition according to claim 28 in which the mixture of dry, pre gelatinized starch base is combined with inactivated probiotics, prebiotics, enzymes and inactivated yeasts including any of the strains of yeasts of the species Saccharomyces cerevisiae used singly or in combination, used whole or in fractions of the whole yeast organism.

30. A composition according to claim 29 in which the mixture of dry, pre gelatinized starch base is combined with inactivated probiotics, prebiotics, enzymes, inactivated yeasts and botanicals including garlic or garlic extracts used singly or in combination.

31. A composition according to claim 30 in which the mixture of dry, pre gelatinized starch base is combined with inactivated probiotics, prebiotics, enzymes, inactivated yeasts or botanicals and dry, lactose free milk powder or lactose free yoghurt powder.

32. A composition according to claim 31 in which the mixture of pre gelatinized starch base is combined with inactivated probiotics, prebiotics, enzymes, inactivated yeasts, botanicals, vitamin and mineral supplements, anti oxidants, preservatives, and colourings.
